(19) United States
(12) Patent Application Publication
(10) Pub. No.: US 2012/0246265 A1
(43) Pub. Date: Sep. 27, 2012

(54) TIME SYNCHRONIZATION IN WIRELESS NETWORKS

(75) Inventor: Gabor Bajko, Sunnyvale, CA (US)

(73) Assignee: Nokia Corporation, Espoo (FI)

(21) Appl. No.: 13/389,982

(22) PCT Filed: Aug. 10, 2010
(86) PCT No.: PCT/IB2010/053607

§ 371 Date: Mar. 30, 2012

Related U.S. Application Data
(60) Provisional application No. 61/233,783, filed on Aug. 13, 2009.

(51) Int. Cl. G06F 15/16; H04W 84/02

(52) U.S. Cl. 709/217

(57) ABSTRACT

A system for facilitating the distribution of timing information amongst apparatuses interacting via wired and/or wireless communication (e.g., as members of a network or during ad-hoc interactions). Apparatuses may record when messages are sent and received. This information may be conveyed between the apparatuses via specifically configured messages. For example, these messages may contain a plurality of fields wherein at least one of the plurality of fields is a timing measurement control field. The configuration of the timing variable control field may dictate how timing information is shared amongst the apparatuses.

### BACKGROUND OF THE INVENTION

1. Field of Invention

The present invention relates to synchronizing apparatus operation in wireless networks, and more specifically, to facilitating the exchange information used in synchronizing apparatus timing through request and/or response messages exchanged on the wireless network.

2. Background:

Wireless technology continues to proliferate in view of strong consumer demand. For example, many apparatuses now incorporate wireless communication features that allow these devices to interoperate by transmitting and receiving wireless messages. A plurality of apparatuses interacting in this matter may be deemed to be operating within a wireless network. Network operation may allow apparatuses to exchange information while realizing benefits such as enhanced communication speed and/or data-handling capacity, error correction, security, etc.

Example networks may be implemented using wireless communication protocols that govern how participating apparatuses may interact. Wireless communication protocols may operate over long distances (e.g., cellular), short distances (e.g., Bluetooth, wireless local area networking (WLAN), etc.) or even in close-proximity situations (e.g., near field communication (NFC), etc.). One aspect that may influence the operation of such communication transports is synchronization (e.g., computing an offset of absolute time with respect to other apparatuses in the network). For instance, each networked apparatus may operate based on its own clock. However, communication between the apparatuses may be negatively impacted if the clocks are not synchronized. For example, clock synchronization may be important for managing network communication activities such as channel access, apparatus mode control (e.g., transmit/receive mode, sleep mode, etc.), interference (e.g., collision) prevention, packet retransmission, etc.

In addition to the basic functionality discussed above, more complex functionality may also be influenced by clock synchronization. For example, the distance between networked apparatuses may be estimated based on message transmission duration and signal transmission speed. However, the accuracy of such estimations may be adversely affected when the clocks in apparatuses that are creating reception and transmission timestamps are not synchronized.

### SUMMARY OF INVENTION

Various embodiments of the present invention are directed to at least a method, computer program product, apparatus and system for facilitating the distribution of timing information amongst apparatuses interacting via wired and/or wireless communication (e.g., as members of a network or during ad-hoc interactions). Apparatuses may record when messages are sent and received, for example, as part of timing measurement operations. This information may be conveyed between the apparatuses via specifically configured messages. For example, these messages may contain a plurality of fields wherein at least one of the plurality of fields is a timing measurement control field. The configuration of the timing variable control field may dictate how timing information is shared amongst the apparatuses that are involved in the timing measurement operations.

In at least one example embodiment of the present invention, specially configured messages may be defined in terms of the wireless communication protocol being employed, such as how IEEE 802.11(v) defines timing measurement action frames. These messages may include a timing measurement control field in which bits may be configured to convey characteristics about the message. For example, the configuration of the timing measurement control field may instruct a received apparatus to record timestamps for received and transmitted messages, that the present message is triggered by a previous request for timing information, or that the present message is requesting an apparatus to provide certain timing information in a response message.

In an example scenario where the configuration of a received message indicates that timestamps should be recorded, an apparatus may record when a message is received and when an acknowledgement to the received message is transmitted. This information may be provided to other apparatuses when requested. For example, timing measurement control field configurations may include requests for information that cause apparatuses to compose and transmit response messages including the timestamps. Similarly, apparatuses may also request that timing information be provided, and response messages containing the requested timing information may indicate as such in the configuration of the timing measurement control field.

The above summarized configurations or operations of various embodiments of the present invention have been provided merely for the sake of explanation, and therefore, are not intended to be limiting. Moreover, inventive elements associated herein with a particular example embodiment of the present invention can be used interchangeably with other example embodiments depending, for example, on the manner in which an embodiment is implemented.

### DESCRIPTION OF DRAWINGS

Various example embodiments of the present invention will be further understood from the following detailed description, taken in conjunction with appended drawings, in which:

FIG. 1A discloses an operational environment comprising example apparatuses that may be utilized when implementing the various embodiments of the present invention.

FIG. 1B discloses further detail with respect to example interfaces that may exist within apparatuses usable in accordance with at least one embodiment of the present invention.

FIG. 2 discloses an example message structure usable in accordance with at least one embodiment of the present invention.

FIG. 3 discloses an example interaction between apparatuses in accordance with at least one embodiment of the present invention.

FIG. 4 discloses an example message structure including a timing measurement control field in accordance with at least one example embodiment of the present invention.

FIG. 5A discloses a possible effect of the inclusion of a timing measurement control field on the example interaction between apparatuses of FIG. 3.

FIG. 5B expands upon the example interaction of FIG. 5A by proceeding further with the example in accordance with at least one example embodiment of the present invention.

FIG. 5C expands upon the example interaction of FIG. 5B by proceeding further with the example in accordance with at least one example embodiment of the present invention.

FIG. 6 discloses a flowchart of an example timing information communication process in accordance with at least one embodiment of the present invention.

### DESCRIPTION OF EMBODIMENTS

While the invention has been described below in terms of a multitude of example embodiments, various changes can be made therein without departing from the spirit and scope of the invention, as described in the appended claims.

I. Example System with which Embodiments of the Present Invention May be Implemented

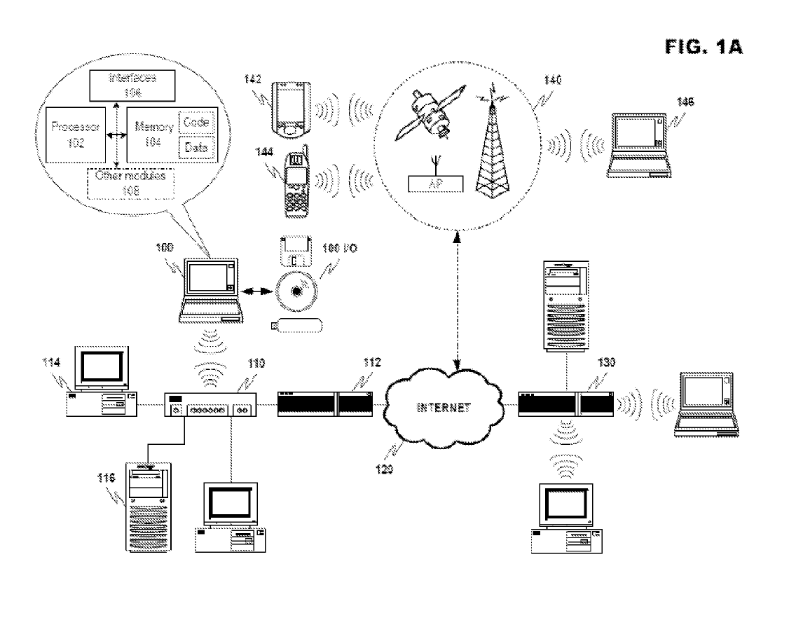

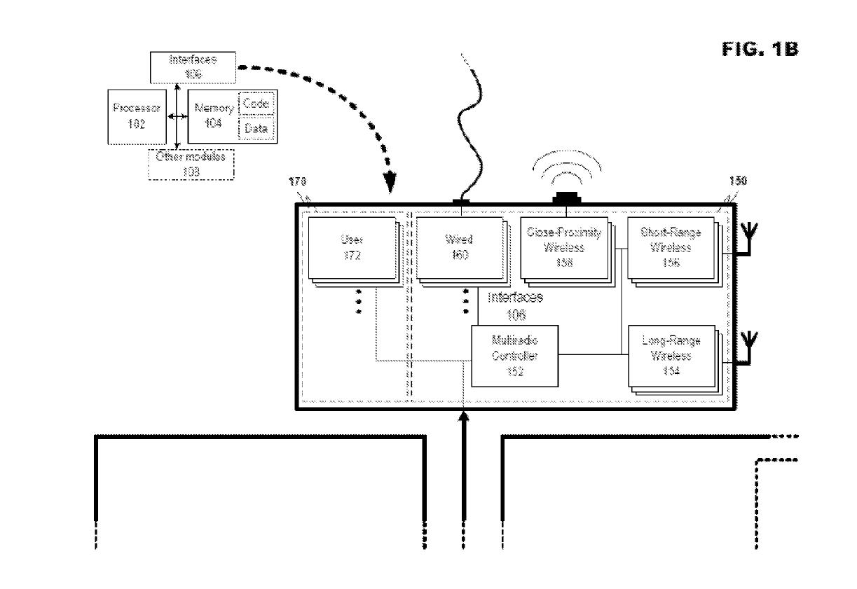

An example of a system that is usable for implementing various embodiments of the present invention is disclosed in FIG. 1A. The system comprises elements that may be included in, or omitted from, configurations depending, for example, on the requirements of a particular application, and therefore, is not intended to limit present invention in any manner.

Computing device 100 may be, for example, a laptop computer. Elements that represent basic example components comprising functional elements in computing device 100 are disclosed at 102-108. Processor 102 may include one or more devices configured to execute instructions. In at least one scenario, the execution of program code (e.g., groups of computer-executable instructions stored in a memory) by processor 102 may cause computing device 100 to perform processes including, for example, method steps that may result in data, events or other output activities. Processor 102 may be a dedicated (e.g., monolithic) microprocessor device, or may be part of a composite device such as an ASIC, gate array, multi-chip module (MCM), etc.

Processor 102 may be electronically coupled to other functional components in computing device 100 via a wired or wireless bus. For example, processor 102 may access memory 102 in order to obtain stored information (e.g., program code, data, etc.) for use during processing. Memory 104 may generally include removable or imbedded memories that operate in a static or dynamic mode. Further, memory 104 may include read only memories (ROM), random access memories (RAM), and rewritable memories such as Flash, EPROM, etc. Examples of removable storage media based on magnetic, electronic and/or optical technologies are shown at 100I/O in FIG. 1, and may serve, for instance, as a data input/output means. Code may include any interpreted or compiled computer language including computer-executable instructions. The code and/or data may be used to create software modules such as operating systems, communication utilities, user interfaces, more specialized program modules, etc.

One or more interfaces 106 may also be coupled to various components in computing device 100. These interfaces may allow for inter-apparatus communication (e.g., a software or protocol interface), apparatus-to-apparatus communication (e.g., a wired or wireless communication interface) and even apparatus to user communication (e.g., a user interface). These interfaces allow components within computing device 100, other apparatuses and users to interact with computing device 100. Further, interfaces 106 may communicate machine-readable data, such as electronic, magnetic or optical signals embodied on a computer readable medium, or may translate the actions of users into activity that may be understood by computing device 100 (e.g., typing on a keyboard, speaking into the receiver of a cellular handset, touching an icon on a touch screen device, etc.) Interfaces 106 may further allow processor 102 and/or memory 104 to interact with other modules 108. For example, other modules 108 may comprise one or more components supporting more specialized functionality provided by computing device 100.

Computing device 100 may interact with other apparatuses via various networks as further shown in FIG. 1A. For example, hub 110 may provide wired and/or wireless support to devices such as computer 114 and server 116. Hub 110 may be further coupled to router 112 that allows devices on the local area network (LAN) to interact with devices on a wide area network (WAN, such as Internet 120). In such a scenario, another router 130 may transmit information to, and receive information from, router 112 so that devices on each LAN may communicate. Further, all of the components depicted in this example configuration are not necessary for implementation of the present invention. For example, in the LAN serviced by router 130 no additional hub is needed since this functionality may be supported by the router.

Further, interaction with remote devices may be supported by various providers of short and long range wireless communication 140. These providers may use, for example, long range terrestrial-based cellular systems and satellite communication, and/or short-range wireless access points in order to provide a wireless connection to Internet 120. For example, personal digital assistant (PDA) 142 and cellular handset 144 may communicate with computing device 100 via an Internet connection provided by a provider of wireless communication 140. Similar functionality may be included in devices, such as laptop computer 146, in the form of hardware and/or software resources configured to allow short and/or long range wireless communication.

Further detail regarding example interface component 106, shown with respect to computing device 100 in FIG. 1A, is now discussed with respect to FIG. 1B. Initially, interfaces such as disclosed at 106 are not limited to use only with computing device 100, which is utilized herein only for the sake of explanation. As a result, interface features may be implemented in any of the apparatuses that are disclosed in FIG. 1 (e.g., 142, 144, etc.) As previously set forth, interfaces 106 may include interfaces both for communicating data to computing apparatus 100 (e.g., as identified at 150) and other types of interfaces 170 including, for example, user interface 172. A representative group of apparatus-level interfaces is disclosed at 150. For example, multiradio controller 152 may manage the interoperation of long range wireless interfaces 154 (e.g., cellular voice and data networks), short-range wireless interfaces 156 (e.g., Bluetooth and WLAN networks), close-proximity wireless interfaces (e.g., for interactions where electronic, magnetic, electromagnetic and optical information scanners interpret machine-readable data), wired interfaces 160 (e.g., Ethernet), etc. The example interfaces shown in FIG. 1B have been presented only for the sake of explanation herein, and thus, are not intended to limit the various embodiments of the present invention to utilization of any particular interface. Embodiments of the present invention may also utilize interfaces that are not specifically identified in FIG. 1B.

Multiradio controller 152 may manage the operation of some or all of interfaces 154-160. For example, multiradio controller 152 may prevent interfaces that could interfere with each other from operating at the same time by allocating specific time periods during which each interface is permitted to operate. Further, multiradio controller 152 may be able to process environmental information, such as sensed interference in the operational environment, to select an interface that will be more resilient to the interference. These multiradio control scenarios are not meant to encompass an exhaustive list of possible control functionality, but are merely given as examples of how multiradio controller 152 may interact with interfaces 154-160 in FIG. 1B.

### II. Example Timing Measurement Action Frame

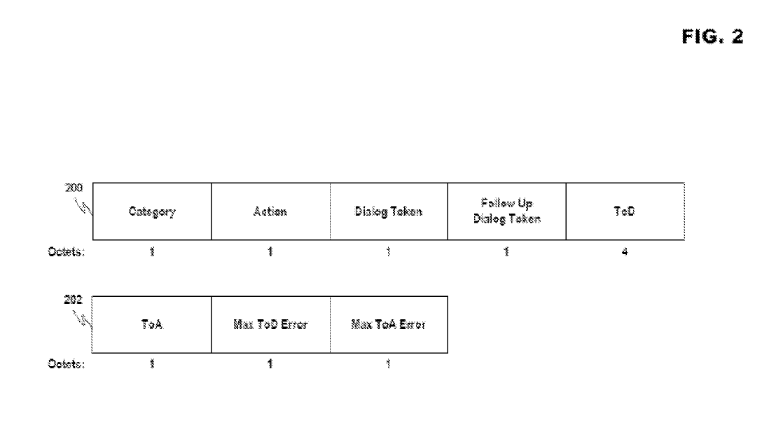

Now referring to FIG. 2, an example of a message for performing timing-related activities is now disclosed. The field structure shown at 200 and 202 for the timing measurement action frame disclosed in FIG. 2 corresponds to a definition proposed for the IEEE 802.11(v) standard, may be referred to generally as the most recently proposed standard for wireless local area networking (WLAN). While this structure, as defined in the IEEE 802.11(v) specification, will be referred to herein, its use is solely for the purpose of explanation herein, and thus, is not intended to limit the scope of the various embodiments of the present invention. As a result, the present invention, in accordance with its various embodiments, may be implemented with structures defined in similarly functioning wired or wireless communication protocols existing now or in the future. For example, the various methodologies expressed herein are also readily applicable to existing wired network protocols such as defined in IEEE 802.1 and IEEE 802.3.

As defined in the draft IEEE 802.11(v) specification, which has been utilized as an example herein, stations that support timing measurement may provide timing measurement values to peer stations that support timing measurement using the timing measurement action frame. The fields defined in the example timing measurement action frame of FIG. 2 may include a Category field, an Action field, a Dialog Token field, a Follow up Dialog Token field, a Time of Departure (ToD) field, a Time of Arrival (ToA) field a maximum Time of Departure error (Max ToD Error) field and a maximum Time of Arrival error (Max ToA Error) field. Receiving stations may then utilize the timing values provided by the Timing Measurement action frame, along with timing information derived locally, to estimate the offset of the clock local to the station with respect to the clock of the station that originally transmitted the frame.

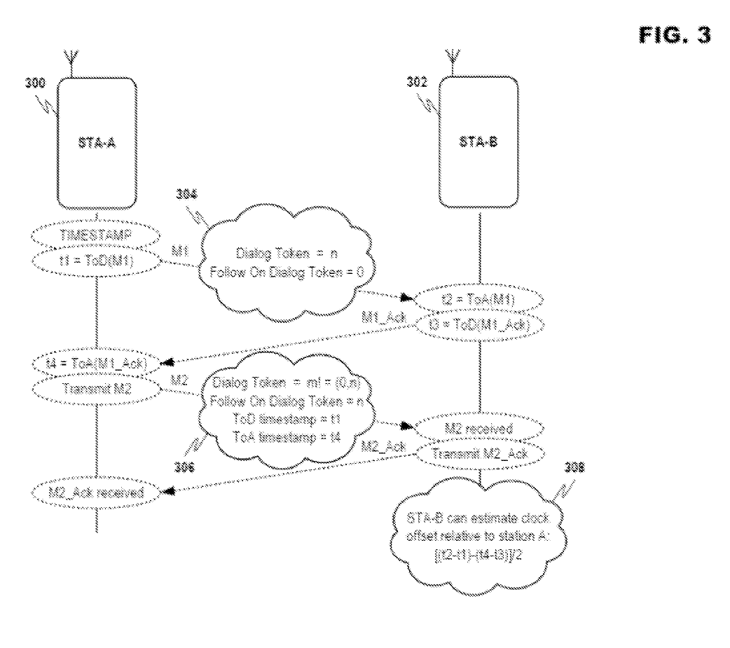

Timing measurement, in accordance with the example scenario shown in FIG. 3, requires two timing measurement action frames to be sent from STA-A 300 to a STA-B 302. STA-A 300 initially sends message M1 304 to STA-B 302. As shown at 304, message M1 may include field values that pertain to, for example, the current stage of the synchronization process.

This frame may be received by STA-B 302 and then acknowledged. The time of arrival of M1, ToA(M1), may be stored as timestamp t2 and a timestamp corresponding to the departure of message M1_Ack acknowledging the receipt of M1, ToD(M1_Ack) may be recorded as t3. The time of arrival of the M1_Ack message at STA A 300 may then be recorded as timestamp t4.

The second message required in the synchronization process described in FIG. 3 may be M2 306. The contents of M2 306 may include, in addition to values that describe the current stage of the synchronization process, the timestamp values for t1 and t4. The receipt of message M2 306, and hence the t1 and t4 values contained in M2 306, may be acknowledged via message M2_Ack. At the end of the transaction (308), STA-B 302 has enough information to synchronize the local clock to the clock at STA-A. The offset for the STA-B 302 clock with respect to the STA-A 300 clock may be estimated as [(t2−t1)−(t4−t3)]/2, wherein values t1, t2, t3 and t4 are known only by STA-B 302.

In accordance with various embodiments of the present invention, the follow up dialog token field in the action frame may be used to identify each of the action frames in the Timing Measurement transaction. When a STA-A 300 initiates the timing measurement procedure, it shall send an Initial Timing Measurement action frame where the Dialog Token is set to a non-zero value (n) and the Follow Up Dialog Token field set to zero (indicating that the ToD, ToA, Max ToD Error and Max ToA Error fields are not present in the frame). STA-A 300 records a value for t4 when the start of the preamble for the incoming frame arrives at the receive antenna of STA-A 300. STA-A 300 may then transmit a Follow Up Timing Measurement action frame where the Dialog Token is set to a non-zero value (different from the value n), the Follow Up Dialog Token set to the value n, ToD field set to t1 (see Figure v113), ToA field set to t4 and corresponding values of Max ToD Error and Max ToA Error.

If the M1_Ack is not received, STA-A 300 may retransmit the Initial Timing Measurement action frame in one of the following ways: a) Initial Timing Measurement action frame may be retransmitted by the MLME at STA-A 300 wherein, prior to retransmission of M1 304, the MLME shall discard data corresponding to the unacknowledged action frame; or b) M1 304 may be retransmitted by the SME at STA-A 300 requiring no special activity at the station.

On receipt of the M1 304 retransmission, STA-B 302 shall discard data, if any, corresponding to a previously received M1 304 with the same Dialog Token. This is true since STA-B 302 is expecting a Follow Up Timing Measurement action frame (M2 in FIG. 3) while it is receiving a retransmitted M1 304. If the M2_Ack is not received, it may be retried first by the MLME and then by the SME at STA-A 300. If STA-B 302 successfully receives M2, it shall ignore re-transmissions of M2 306 with the same Dialog Token and Follow Up Dialog Token, from STA-A 300. If STA-B 302 does not receive M2 306 with the Follow Up Dialog Token set to the Dialog Token of M1 304 but receives a M1 304, it means that STA-A 300 has aborted the previous synchronization transaction and restarted a new one. STA-B 302 shall discard data corresponding to the receipt of M1 304 for which a corresponding M2 306 is not received.

### III. Limitations and Solutions

While the example process disclosed in FIG. 3 provides the ability to synchronize the clocks of two apparatuses, it does so with inherent limitations. Initially, the process must proceed exactly as shown. STA-A 300 initiates synchronization, but does not receive timestamp information. Therefore, STA-B 302 must synchronize its clock to STA_A 300. Moreover, STA-B 302, or more generally the apparatus that wishes to synchronize to another apparatuses clock, cannot initiate the transaction. Therefore, STA-B 302 must wait for another apparatus (e.g., STA-A 300) to send the first message. The rigid execution order of these steps limits the ability for apparatuses to stay in synch, which may affect network-level communication performance as well as the performance of device-level operations like distance measurement based on timing. For example, timing measurements may facilitate more accurate “time of flight” calculations. Initially, an offset at receiving apparatus relative to a sending apparatus can be determined using: offset=[(t2−t1)−(t4−t3)]/2. Similarly, the offset at the sending apparatus relative to the receiving apparatus is: offset=−[(t2−t1)−(t4−t3)]/2. The time of flight formula, ToF=[(t2−t1)+(t4−t3)][/2, may then be adjusted using the offset: ToF=[(t2−t1−offset)]+(t4−t3+offset)]/2. When being applied to wired networks, similar formulas may be utilized to calculate round trip time (e.g., RTT=[(t2−t1)+(t4−t3)]) instead of time of flight. In view of the above, it therefore becomes evident that offset measurement may increase the accuracy of ToF and RTT calculations.

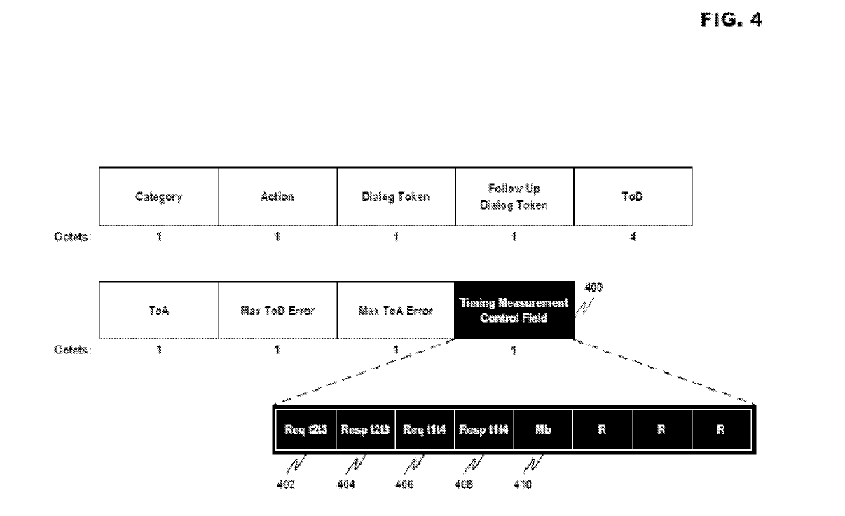

A departure from the proposed IEEE 802.11(v) specification, as described above, is now discussed with respect to FIG. 4. In accordance with various embodiments of the present invention, a time measurement control field 400 is now added to the timing measurement action frame previously described in FIG. 2. As shown in FIG. 4, the time measurement control field 400 may include one octet (eight bits). Five of these bits may be utilized to indicate “Req t2t3” 402, “Resp t2t3” 404, “Req t1t4” 406 “Resp t1t4” 408 and “Mb” 410. The configuration of these bits may impart command information to, or receive command information from, apparatuses.

In particular Req t2t3 402 is set to “1” to indicate that the sender wants to receive values t2 and t3 in a reply message. Otherwise this bit may be set to zero. Resp t2t3 404 is set to “1” to indicate that this action frame carries previously requested values t2 and t3. Otherwise this bit may be set to zero. Req t1t4 406 is set to “1” to indicate that the original receiver (the sender of this action frame) wants to receive values t1 and t4 in a response message. Otherwise this bit may be set to zero. Resp t1t4 408 is set to “1” to indicate that this action frame carries previously requested values t1 and t4. Otherwise this bit may be set to zero. Setting Mb 410 to “1” indicates to receiving apparatuses that measurements were taken by the sending apparatus prior to or during the transmission, and thus, that measurements are also to be recorded by the receiver. For example, when Mb 410=1 the Time of Arrival (ToA) for the received message should be assigned to t2 and that the Time of Departure (ToD) for the message acknowledging the received message should be assigned to t3. The last three bits may be reserved for future use (e.g., “R”).

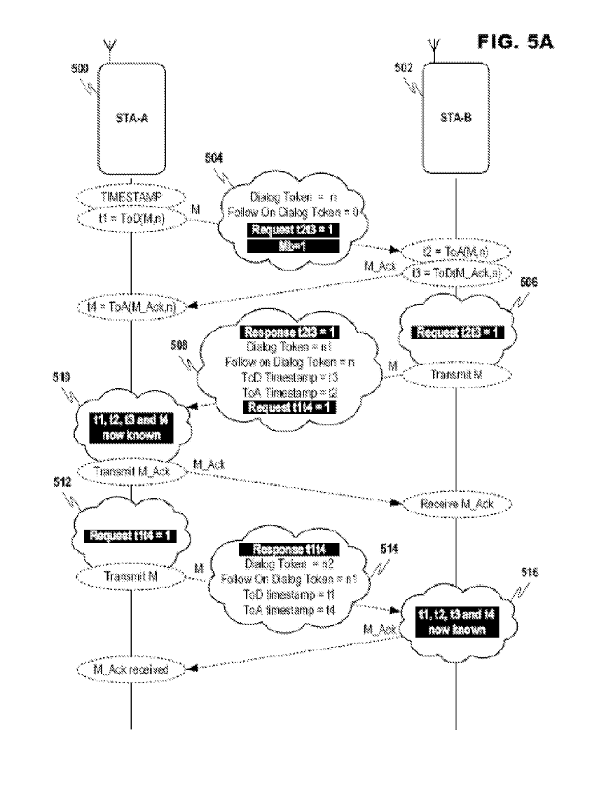

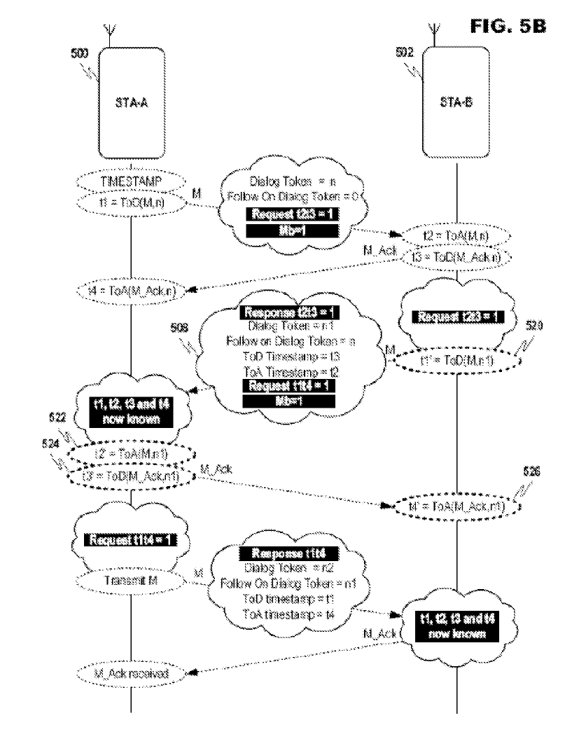

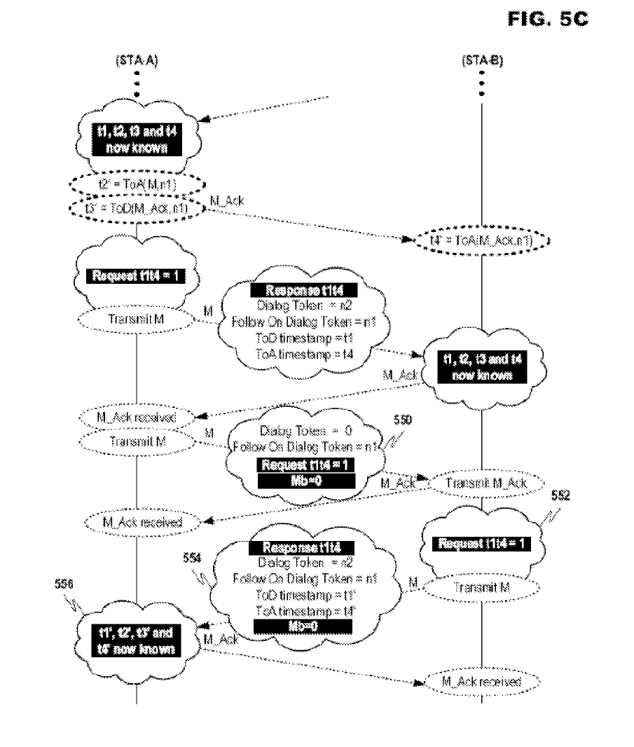

An example of apparatus interaction employing timing measurement control field 400 is disclosed in FIG. 5A. Initially, it is important to realize that with the advent of the control field in the timing measurement action frame that any apparatus may initiate the process. In this example STA_A 500 sends a message M 504 to STA_B 502. STA_A 500 will first timestamp the departure of M 504, which sets t1=Time of Departure M, ToD(M,n) wherein “n” is the Dialog Token, and may automatically set Mb 410=1 since a return timestamp will be required. In accordance with various embodiments of the present invention, “n” may either be attached to or omitted from timestamps. However, regardless of the particular implementation, “n” will still be present somewhere within the frame. STA_B 502 will then timestamp the arrival of M 504 and also the departure of the corresponding acknowledgement frame M_Ack. As part of this initial process t2=Time of Arrival of M, ToA(M,n), and t3=Time of Departure of M_Ack, ToD(M_Ack,n) wherein “n” is the Dialog Token. In accordance with at least one embodiment of the present invention, apparatuses may by default be required to timestamp when an action frame and its corresponding Ack is generated or received, except in instances when Mb 410=“0” in the message (e.g., when Mb 410=“0,” the sender did not timestamp, thus there is no reason for the receiving apparatus to timestamp).

STA-B 502 may recognize that Req t2t3 402=“1” in timing measurement control field 400 of the previously received message at 506. When STA-B 502 generates action frame M 508, it may set Mb 410=“1” to indicate that it has timestamped the ToD of the initial message. M 508 will further include timestamps t2 and t3 in response to STA-A 500's original request and Resp t2t3 404 will be set to “1” to indicate to STA_A 500 that these values are enclosed. Further, STA_B 502 may, in accordance with the disclosed example, further request STA-A 500 to provide timestamps t1 and t4. This is shown in FIG. 5A where Req t1t4 406=“1” in M 508.

STA-A 500 may receive M 508 at 510 and acknowledge the receipt with M_Ack. t1-t4 are now known to STA-A 500, which may utilize these values in performing clock synchronization. STA-A 500 may also recognize at 512 that a request for t1 and t4 was made in M 508. This request can be seen in the configuration of timing measurement control field 400 of M 508 wherein Req t1t4=“1.” STA-A 500 may then compose message M 514 to STA_B 502. M 514 may include, among other things, the values of t1 and t4 and Resp t1t4 408 may be set to “1” to indicate the content of the message to STA_B 502. After receipt (and acknowledgement) of M 514 STA_B 502 will know the values of all timestamps t1, t2, t3 and t4 at 516. STA_B 502 may then perform synchronization calculations such as previously described.

Any message (e.g., timing measurement action frame) can be used to timestamp the time of departure (ToD) and time of arrival (ToA) values (t1-t4). Each set of timestamps (t1, t4) and (t2, t3) may be associated with a dialog token. When messages are used to carry timer values to another apparatus, the Follow on Dialog Token field may indicate which measurement procedure they belong to by being set to the value of the dialog token used to timestamp. The example procedure presented above is symmetric in that STA_B 502 can take measurements on the action frame it sends to STA_A 500 carrying values t2, t3 (and requesting timestamps for t1 and t4), but it needs to set the Dialog Token field to a value not used as of yet. The Follow on Dialog Token will then be set to the value of the dialog token to which t2 and t3 belong. The procedure can be performed continuously by keeping Mb 410 set to “1.” When the originator of the measurement procedure (e.g., STA_B 502) sets the Mb 410 to zero, the procedure terminates, but it can be restarted by either apparatus at any time.

An example of a mirror image of the FIG. 5A interaction is shown with respect to FIGS. 5B and 5C. This process begins during the latter steps of the FIG. 5A process. While STA-B 502 sends the requested timestamps regarding the earlier measurement frame exchange to STA-A 500, it also initiates a new interaction by recording a timestamp for the departure of M 508 at 520 in FIG. 5B. Mb 410=“1” in M 508 since the departure of M 508 was recorded (e.g., t1′=ToD(M,n1), wherein n1 is the Dialog Token). STA A 500 may receive M 508, and because Mb 410 is set to “1” in M 508, STA-A 500 will also record new timestamps for t2′=ToA(M,n1) as shown at 522 and for t3′=ToD(M_Ack,n1) as shown at 524. In addition, upon the arrival of the M_Ack STA-B 502 will record a new timestamp for t4′=ToA(M_Ack,n1) as shown at 526.

The example process of FIG. 5B continues in FIG. 5C. After timestamps are recorded for t1′, t2′, t3′ and t4′, these values may be distributed amongst the apparatuses that are participating in the timing measurement process at any time within Ts time period following the recording. For example, STA-A 500 may send M 550 to STA-B 502 with the req t1t4 bit set. STA-B 502 may receive and acknowledge M 550, and then may formulate M 554 in order to respond to the request for timing information. M 554 may indicate resp t1t4 in its timing measurement control field and may comprise at least the values for t1′ and t4′. As shown at 506 in FIG. 5C, STA-A 500 may receive (and acknowledge) M 554, and thereby obtain the values for t1′ and t4′ from this message. STA-A 500 will then have all of the values t1′, t2′, t3′ and t4′ needed in order to calculate timer offset, time of flight, etc.

In accordance with at least one embodiment of the present invention, the procedure may still function even if there is no M bit in the control field. In that case, both peers will be required to timestamp any Timing Measurement action frame's ToD and ToA. Either peer is able to request the timestamps taken at an earlier measurement by setting the Follow on Dialog Token field to the value of the Dialog Token belonging to the requested timer values and setting the corresponding bit in the control field (indicating the timer values being requested). The tuple [dialog_token, t1, t2, t3, t4] is stored in the peer stations for a certain time Ts. After that, it is discarded. This is to prevent the case when, after a number of measurements, the peer ends up re-using a previously used value for the dialog token (regardless of whether the peer uses a random number generator for the dialog token field or simply increments the previous value). After time Ts, the peer can no longer request the corresponding timer values.

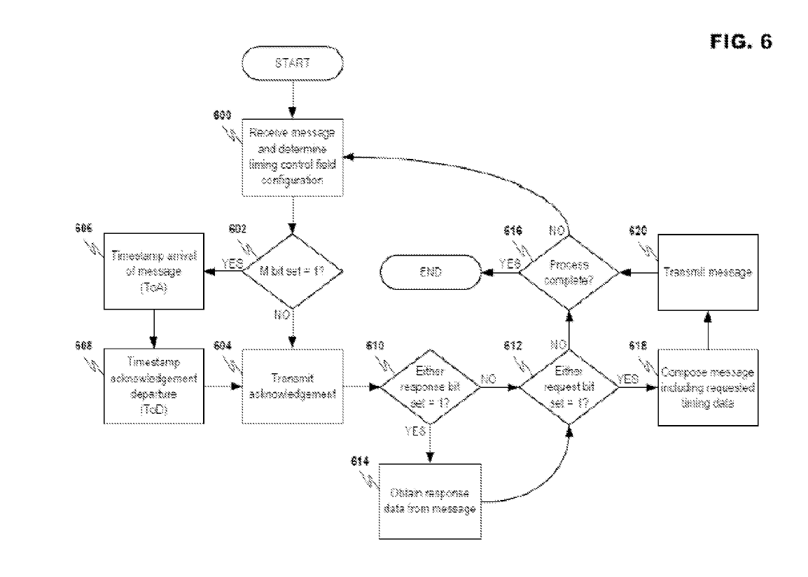

A flowchart for an example process in accordance with at least one embodiment of the present invention is now disclosed with respect to FIG. 6. The process may initiate with step 600, wherein a message may be received in an apparatus. This message may be, for example, a timing measurement action frame including one or more fields. At least one of these fields may be a timing measurement control field, the configuration of which may also be determined in step 600. The configuration of the timing measurement control field may include one or more bits that are set to either “0” or “1” depending on the functionality desired. For example, a determination may be made in step 602 as to whether the M bit is set to “1” in the timing measurement control field. If the M bit=“0” then steps 606 and 608 may be skipped and a message acknowledging the receipt of the received message may be sent without recording any timestamps. However, when the M bit=“1” the arrival time (ToA) of the message is recorded as a timestamp in step 606 and the departure time (ToD) of the acknowledgement message is recorded as a timestamp in step 608. The process may then proceed to step 604 where the acknowledgement message is sent.

In step 610 a determination may be made as to whether either response bit (e.g., “Resp t2t3” or “Resp t1t4”) is set to “1.” If either of the bits=“1” the process may continue to step 614 wherein response information may be obtained from the message originally received in step 600. Response information may include, for example, timestamps that were requested from another apparatus. Regardless of outcome of the determination in step 610, the process may eventually proceed to step 612 wherein a further determination may be made as to whether either of the request bits (e.g., “Req t2t3” or “Req t1t4”) is set to “1.” If neither bit is determined to be “1” in step 612, then a determination may be made as to whether the process is complete in step 616. The process may then either end as shown in FIG. 6, or alternatively, it may return to step 600 to await the receipt of another message (e.g., another timing measurement action frame).

Determining that either of these bits are set to “1” in step 612 would indicate that information is being requested from the apparatus that received the message in step 600. The process may then proceed to step 618 wherein a response message may be composed including at least the requested timing data and a timing measurement control field with one of the two response indicator bits set to “1” to signify that the message is a response message. The message may then be transmitted in step 620 and a determination may be made as to whether the process is complete in step 616. The process may then either end, or alternatively, it may return to step 600 to await the receipt of another message (e.g., another timing measurement action frame).

The various embodiments of the present invention are not limited only to the examples disclosed above, and may encompass other configurations or implementations. For example, example embodiments of the present invention may encompass methods comprising steps such as receiving a message in an apparatus, determining a configuration for a timing control field in the received message, if configured in the timing control field, recording a receipt time for the received message and a time for transmitting a message acknowledging the received message, transmitting the message acknowledging the received message, if the configuration of the timing control field indicates that the received message is a response message, obtaining timestamp information from the received message, and if the configuration of the timing control field indicates that the received message is a request message, composing and then transmitting a response message comprising information requested in accordance with the configuration of timing control field.

These methods may further be defined, wherein the received message is a timing measurement action frame defined for wireless local area networking (WLAN). These methods may further be defined, wherein the time for transmitting a message acknowledging the received message is substantially the same as the time that the message acknowledging the received message was transmitted. These methods may further be defined, wherein the received message comprises a plurality of fields, including at least the timing control field, which further comprises one or more bits, and in particular, wherein the one or more bits in the timing control field indicate at least one of that timestamp information is not required by the initiating apparatus, that the received message is requesting timestamp information or that the received message is responding to a previous request for timestamp information. These methods may further be defined, wherein the information requested in accordance with the configuration of timing control field is timestamp information. These methods may further be defined, wherein the timestamp information is utilized in the apparatus for computing a timing offset relative to a clock residing in another apparatus.

Other example embodiments of the present invention may encompass a computer program product comprising computer executable program code recorded on a computer readable medium, the computer executable program code comprising code configured to receive a message in an apparatus, code configured to determining a configuration for a timing control field in the received message, code configured to, if configured in the timing control field, record a receipt time for the received message and a time for transmitting a message acknowledging the received message, code configured to transmit the message acknowledging the received message, code configured to, if the configuration of the timing control field indicates that the received message is a response message, obtain timestamp information from the received message, and code configured to, if the configuration of the timing control field indicates that the received message is a request message, compose and then transmit a response message comprising information requested in accordance with the configuration of timing control field.

These computer program products may further be defined, wherein the received message is a timing measurement action frame defined for wireless local area networking (WLAN). These computer program products may further be defined, wherein the time for transmitting a message acknowledging the received message is substantially the same as the time that the message acknowledging the received message was transmitted. These computer program products may further be defined, wherein the received message comprises a plurality of fields, including at least the timing control field, which further comprises one or more bits, and in particular, wherein the one or more bits in the timing control field indicate at least one of that timestamp information is not required by the initiating apparatus, that the received message is requesting timestamp information or that the received message is responding to a previous request for timestamp information. These computer program products may further be defined, wherein the information requested in accordance with the configuration of timing control field is timestamp information. These computer program products may further be defined, wherein the timestamp information is utilized in the apparatus for computing a timing offset relative to a clock residing in another apparatus.

Other example embodiments of the present invention may encompass an apparatus, comprising at least one processor and at least one memory including executable instructions, the at least one memory and the executable instructions being configured to, in cooperation with the at least one processor, cause the device to receive a message in the apparatus, determine a configuration for a timing control field in the received message, if configured in the timing control field, record a receipt time for the received message and a time for transmitting a message acknowledging the received message, transmit the message acknowledging the received message, if the configuration of the timing control field indicates that the received message is a response message, obtain timestamp information from the received message, and if the configuration of the timing control field indicates that the received message is a request message, compose and then transmit a response message comprising information requested in accordance with the configuration of timing control field.

These apparatuses may be further defined, wherein the received message is a timing measurement action frame defined for wireless local area networking (WLAN). These apparatuses may be further defined, wherein the time for transmitting a message acknowledging the received message is substantially the same as the time that the message acknowledging the received message was transmitted. These apparatuses may be further defined, These apparatuses may be further defined, wherein the received message comprises a plurality of fields, including at least the timing control field, which further comprises one or more bits, and in particular, wherein the one or more bits in the timing control field indicate at least one of that timestamp information is not required by the initiating apparatus, that the received message is requesting timestamp information or that the received message is responding to a previous request for timestamp information. These apparatuses may be further defined, wherein the information requested in accordance with the configuration of timing control field is timestamp information. These apparatuses may be further defined, wherein the timestamp information is utilized in the apparatus for computing a timing offset relative to a clock residing in another apparatus.

Other example embodiments of the present invention may encompass an apparatus, comprising means configured to receive a message in the apparatus, means for determining a configuration for a timing control field in the received message, means configured to, if configured in the timing control field, record a receipt time for the received message and a time for transmitting a message acknowledging the received message, means configured to transmit the message acknowledging the received message, means configured to, if the configuration of the timing control field indicates that the received message is a response message, obtain timestamp information from the received message, and means configured to, if the configuration of the timing control field indicates that the received message is a request message, compose and then transmit a response message comprising information requested in accordance with the configuration of timing control field.

Other example embodiments of the present invention may encompass a system, comprising an initiating apparatus and at least one requesting apparatus, the initiating apparatus transmitting a message to the at least one requesting apparatus, the at least one requesting apparatus determining a configuration for a timing control field in the received message, and if configured in the timing control field, recording a receipt time for the received message and a time for transmitting a message acknowledging the received message, the at least one requesting apparatus further transmitting the message acknowledging the received message to the initiating apparatus, the at least one requesting apparatus further, if the configuration of the timing control field indicates that the received message is a response message, obtaining timestamp information from the received message, and if the configuration of the timing control field indicates that the received message is a request message, composing and then transmitting, to the initiating apparatus, a response message comprising information requested in accordance with the configuration of timing control field.

Other example embodiments of the present invention may encompass electronic signals that cause apparatuses to receive a message in an apparatus, determine a configuration for a timing control field in the received message, if configured in the timing control field, record a receipt time for the received message and a time for transmitting a message acknowledging the received message, transmit the message acknowledging the received message, if the configuration of the timing control field indicates that the received message is a response message, obtain timestamp information from the received message, and if the configuration of the timing control field indicates that the received message is a request message, compose and then transmit a response message comprising information requested in accordance with the configuration of timing control field.

Accordingly, it will be apparent to persons skilled in the relevant art that various changes in forma and detail can be made therein without departing from the spirit and scope of the invention. The breadth and scope of the present invention should not be limited by any of the above-described exemplary embodiments, but should be defined only in accordance with the following claims and their equivalents.

1. A method, comprising:
receiving a message in an apparatus;
determining a configuration of a timing control field in the received message;
if configured in the timing control field, recording a receipt time for the received message and a time for transmitting a message acknowledging the received message;
transmitting the message acknowledging the received message;
if the configuration of the timing control field indicates that the received message is a response message, obtaining timestamp information from the received message; and
if the configuration of the timing control field indicates that the received message is a request message, composing and then transmitting a response message comprising information requested in accordance with the configuration of timing control field.

2. The method of claim 1, wherein the received message is a timing measurement action frame defined for wireless local area networking (WLAN).

3. The method of claim 1, wherein the time for transmitting a message acknowledging the received message is substantially the same as the time that the message acknowledging the received message is transmitted.

4. The method of claim 1, wherein the received message comprises a plurality of fields, including at least the timing control field, which further comprises one or more bits.

5. The method of claim 4, wherein the one or more bits in the timing control field indicate at least one of that timestamp information is not required by the initiating apparatus, that the received message is requesting timestamp information or that the received message is responding to a previous request for timestamp information.

6. The method of claim 1, wherein the information requested in accordance with the configuration of timing control field is timestamp information.

7. A computer program product comprising computer executable program code recorded on a computer readable medium, the computer executable program code comprising:
code configured to receive a message in an apparatus;
code configured to determine a configuration of a timing control field in the received message;
code configured to, if configured in the timing control field, record a receipt time for the received message and a time for transmitting a message acknowledging the received message;
code configured to transmit the message acknowledging the received message;
code configured to, if the configuration of the timing control field indicates that the received message is a response message, obtain timestamp information from the received message; and
code configured to, if the configuration of the timing control field indicates that the received message is a request message, compose and then transmit a response message comprising information requested in accordance with the configuration of timing control field.

8. The computer program product of claim 7, wherein the received message is a timing measurement action frame defined for wireless local area networking (WLAN).

9. The computer program product of claim 7, wherein the time for transmitting a message acknowledging the received message is substantially the same as the time that the message acknowledging the received message is transmitted.

10. The computer program product of claim 7, wherein the received message comprises a plurality of fields, including at least the timing control field, which further comprises one or more bits.

11. The computer program product of claim 10, wherein the one or more bits in the timing control field indicate at least one of that timestamp information is not required by the initiating apparatus, that the received message is requesting timestamp information or that the received message is responding to a previous request for timestamp information.

12. The computer program product of claim 7, wherein the information requested in accordance with the configuration of timing control field is timestamp information.

13. An apparatus, comprising:
at least one processor; and
at least one memory including executable instructions, the at least one memory and the executable instructions being configured to, in cooperation with the at least one processor, cause the device to perform at least the following:
receive a message in the apparatus;
determine a configuration of a timing control field in the received message;
if configured in the timing control field, record a receipt time for the received message and a time for transmitting a message acknowledging the received message;
transmit the message acknowledging the received message;
if the configuration of the timing control field indicates that the received message is a response message, obtain timestamp information from the received message; and
if the configuration of the timing control field indicates that the received message is a request message, compose and then transmit a response message comprising information requested in accordance with the configuration of timing control field.

14. The apparatus of claim 13, wherein the received message is a timing measurement action frame defined for wireless local area networking (WLAN).

15. The apparatus of claim 13, wherein the time for transmitting a message acknowledging the received message is substantially the same as the time that the message acknowledging the received message is transmitted.

16. The apparatus of claim 13, wherein the received message comprises a plurality of fields, including at least the timing control field, which further comprises one or more bits.

17. The apparatus of claim 16, wherein the one or more bits in the timing control field indicate at least one of that timestamp information is not required by the initiating apparatus, that the received message is requesting timestamp information or that the received message is responding to a previous request for timestamp information.

18. The apparatus of claim 13, wherein the information requested in accordance with the configuration of timing control field is timestamp information.

19. An apparatus, comprising:
means for receiving a message in the apparatus;
means for determining a configuration of a timing control field in the received message;
means for, if configured in the timing control field, recording a receipt time for the received message and a time for transmitting a message acknowledging the received message;
means for transmitting the message acknowledging the received message;
means for, if the configuration of the timing control field indicates that the received message is a response message, obtaining timestamp information from the received message; and
means for, if the configuration of the timing control field indicates that the received message is a request message, composing and then transmitting a response message comprising information requested in accordance with the configuration of timing control field.

20. A system, comprising:
an initiating apparatus, and
at least one requesting apparatus
the initiating apparatus transmitting a message to the at least one requesting apparatus;
the at least one requesting apparatus determining a configuration of a timing control field in the received message, and if configured in the timing control field, recording a receipt time for the received message and a time for transmitting a message acknowledging the received message;
the at least one requesting apparatus further transmitting the message acknowledging the received message to the initiating apparatus;
the at least one requesting apparatus further, if the configuration of the timing control field indicates that the received message is a response message, obtaining timestamp information from the received message, and if the configuration of the timing control field indicates that the received message is a request message, composing and then transmitting, to the initiating apparatus, a response message comprising information requested in accordance with the configuration of timing control field.
